(19) United States
(12) Patent Application Publication
(10) Pub. No.: US 2014/0164815 A1
(43) Pub. Date: Jun. 12, 2014

(54) SERVER ANALYZING SYSTEM

(71) Applicants: HON HAI PRECISION INDUSTRY CO., LTD., New Taipei (TW); HONG FU JIN PERCISION INDUSTRY (ShenZhen) CO., LTD ., Shenzhen (CN)

(72) Inventor: KANG-BIN WANG, Shenzhen (CN)

(73) Assignees: HON HAI PRECISION INDUSTRY CO., LTD., New Taipei (TW); HONG FU JIN PERCISION INDUSTRY (ShenZhen) CO., LTD, Shenzhen (CN)

(21) Appl. No.: 13/962,090

(22) Filed: Aug. 8, 2013

(30) Foreign Application Priority Data
Dec. 10, 2012 (CN) 2012105248911

(51) Int. Cl. G06F 1/28

(52) U.S. Cl. CPC G06F 1/28
USPC 713/340

(57) ABSTRACT

A system analyzing system includes a field programmable gate array, a complex programmable logic device electrically connected to the field programmable gate array, a micro control unit electrically connected to the field programmable gate array and a display module electrically connected to micro control unit. The complex programmable logic device and the micro control unit control the field programmable gate array to be powered on/powered off and the field programmable gate array saves the sequence of times when the field programmable gate array is powered on/powered off and displaying the time sequence on the display module, and the micro control unit is capable of receiving a command and sending the command to the field programmable gate array to execute from the display module.

### BACKGROUND

1. Technical Field

The present disclosure relates to a server analyzing system.

2. Description of Related Art

Servers are used in data communication, data processing, storage and management of data, and management consulting. Because the system architecture of the server is complex and strict, engineers need to combine theories and practices on a real server. When verifying signals of the main board of the server, an oscillometer may be connected to the main board via soldering, wherein the server may be destroyed during the soldering processes.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a server analyzing system.

FIG. 2 is a block diagram of an embodiment of a complex programmable logic device of FIG. 1.

FIG. 3 is a block diagram of an embodiment of a field-programmable gate array of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

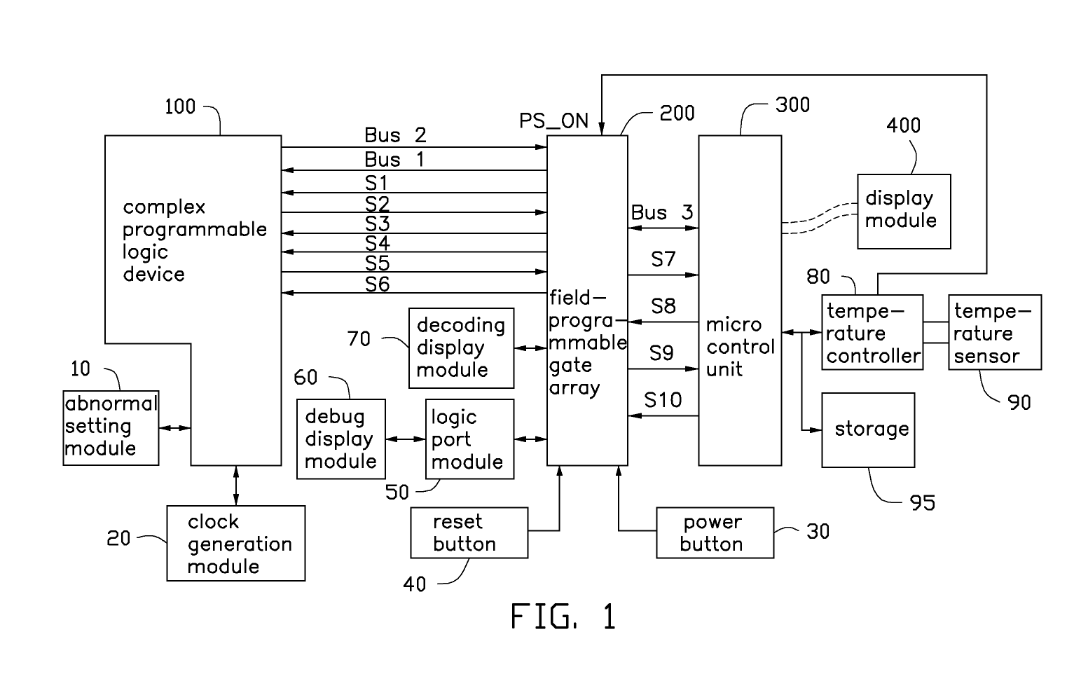

FIG. 1 shows a server analyzing system of one embodiment. The server analyzing system includes a complex programmable logic device (CLPD) 100, a field programmable gate array (FPGA) 200, a micro control unit (MCU) 300, and a display module 400. The complex programmable logic device 100 and the micro control unit 300 are connected to the field-programmable gate array 200 and control the field programmable gate array 200 to detect a number of performance readings in relation to a server, such as power on/off and an abnormal status. The field programmable gate array 200 saves time sequence of the readings and outputs the time sequences on the display module 400.

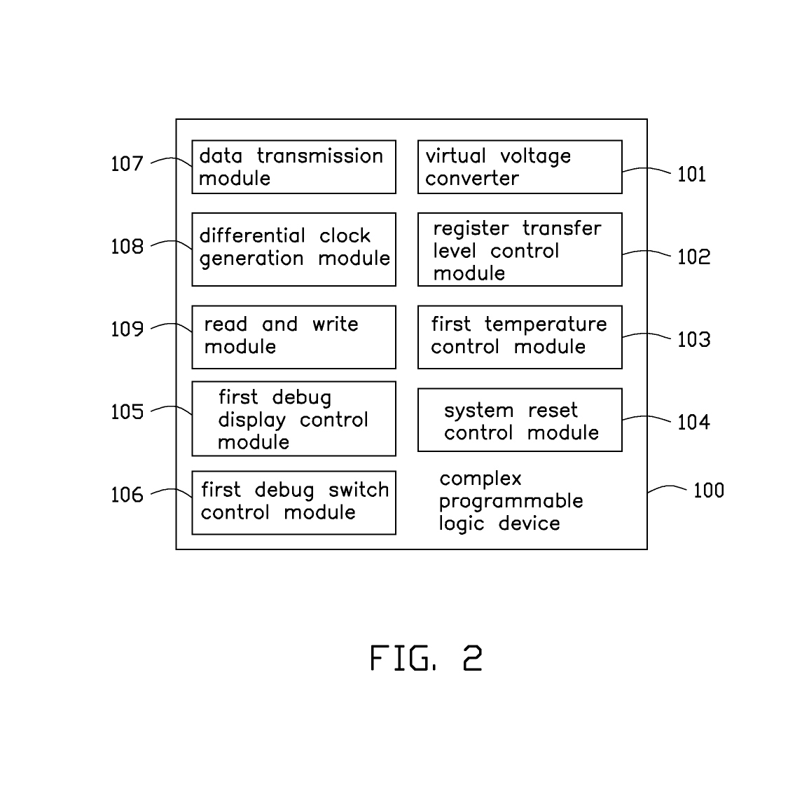

FIG. 2 shows that the complex programmable logic device 100 includes a virtual voltage converter 101, a register transfer level control module 102, a first temperature control module 103, a system reset control module 104, a first debug display control module 105, a first debug switch control module 106, a data transmission module 107, a differential clock generation module 108, and a reading/writing module 109. The server analyzing system further includes an abnormal setting module 10 and a clock generation module 20. The abnormal setting module 10 and the clock generation module 20 are electrically connected to the complex programmable logic device 100. The abnormal setting module 10 includes a plurality of switches for setting different abnormal statuses of the server, for example a 3.5 V module power supply being not powered on normally. The clock generation module 20 generates a plurality of differential clocks to verify signals when a main board of the server has a different layout. The data transmission module 107 transmits data of the complex programmable logic device 100 to the display module 400. The differential clock generation module 108 controls time sequences of clock generation module 20.

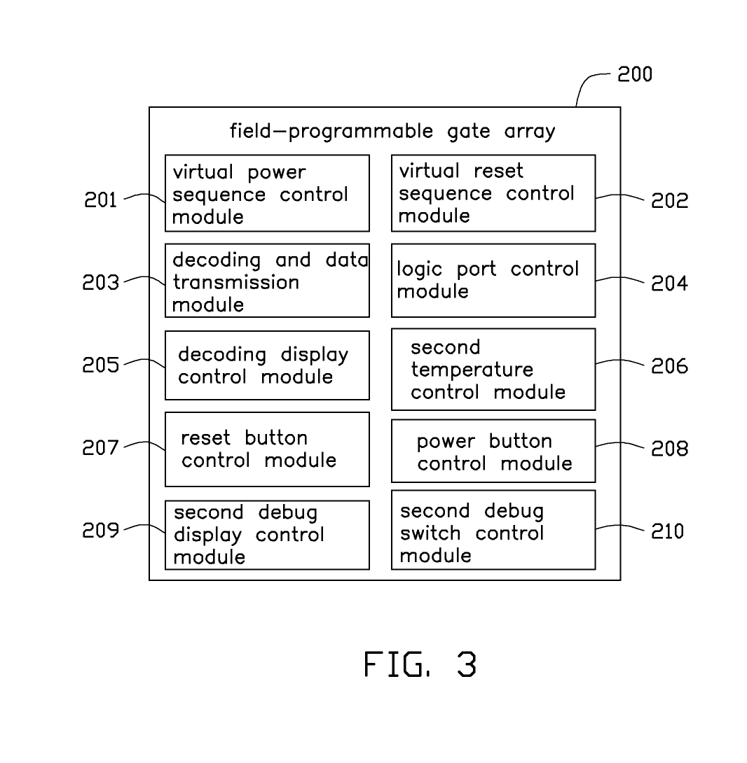

FIG. 3 shows that the field programmable gate array 200 includes a virtual power sequence control module 201, a virtual reset sequence control module 202, a decoding and data transmission module 203, a logic port control module 204, a decoding display control module 205, a second temperature control module 206, a reset button control module 207, a power button control module 208, a second debug display control module 209, and a second debug switch control module 210. The server analyzing system further includes a power switch 30, a reset button 40, a logic port module 50, and a decoding display module 70. The power button 30, the reset button 40, the logic port module 50, and the decoding display module 70 are electrically connected to the field programmable gate array 200. The power button 30 powers on/powers off the field programmable gate array 200. The reset button 40 is used to reset the field programmable gate array 200. A debug display module 60 is electrically connected to the logic port module 50 and used to display signal statuses of the field programmable gate array 200. In one embodiment, the debug display module 60 may be a logic analyzer. The decoding display module 70 is used to display running codes of the field programmable gate array 200 when the field programmable gate array 200 is powered on.

The server analyzing system further includes a temperature controller 80 and a temperature sensor 90. The temperature controller 80 is electrically connected to the micro control module 300, and the temperature sensor 90 is connected to the temperature controller 80. The temperature sensor 90 senses a system temperature and transmits the value of the temperature to the temperature controller 80. The temperature sensor 90 can determine whether or not the system temperature is greater than a predetermined value, and if the system temperature is greater than the predetermined value, the temperature controller 80 sends a temperature abnormal alarm signal to the second temperature control module 206 of the filed programmable gate array 200. The second temperature control module 206 sends the temperature alarm signal to the first temperature control module 103 of the complex programmable logic device 100 via a signal line S6. The first temperature control module 103 sends a notice signal to the virtual voltage converter 101. The virtual voltage converter 101 sends a power off signal, such as a Pch_S1p4 signal, to the virtual power sequence control module 201 via a signal line S2 and sets Pch_S1p4 to be at a low level. The virtual power sequence control module 201 sets a PS_ON pin to be at a high level to power off the system power of the field programmable gate array 200. A storage 95 is connected to the micro control unit 300 and the temperature module 80 and saves read data as it is collected.

When the server analyzing system is used to analyze signals during power on the server in one embodiment, the power button control module 208 receives a power on pulsing signal when the power button 30 is pressed. The power button control module 208 deals with the power on pulsing signal, such as by eliminating dithering of the signal and then sends a power on signal to the virtual voltage converter 101 of the complex programmable logic device 100. The virtual voltage converter 101 sends the power on signal to the virtual power sequence control module 201. The virtual power sequence control module 201 sets the PS_ON pin to be at a low level, and the system power of 12V is thus powered on.

After the system power of 12V is on, the virtual power sequence control module 201 of the field programmable gate array 200 sends a module power supply signal for powering on the module power supplies, such as powering on a module power supply of 0.75V, to the virtual voltage converter 101. The virtual voltage converter 101 powers on the module power supply of 0.75V then sends a feedback signal to the virtual power sequence control module 201 via a signal line Bus_{—}2. The virtual power sequence control module 201 continues to send commands to the complex programmable logic device 100 to power on the module power supplies of 1.0V, 1.5V, 1.8V, 3.3V and 5V in order to provide power to a plurality of modules, for example a fan module. After all modules are powered on, the virtual power sequence control module 201 sends a module power ready signal to the system reset control module 104 via a signal line S3. The system reset control module 104 sends a cease-supply to the virtual voltage converter 101 and sends a reset signal, such as a Plt_Reset signal, to the virtual reset sequence control module 202. The virtual reset sequence control module 202 resets system. The server is thereby powered on.

The reset button control module 207 receives a reset pulsing signal when the reset button 40 is pressed and sends a reset signal to the system reset control module 104. The system reset control module 104 sends the reset signal to the virtual reset sequence control module 202. The virtual reset sequence control module 202 resets all of modules.

When the server analyzing system is used to analyze signals during power off status of the server in one embodiment, the virtual power sequence control module 201 receives a power off pulsing signal when the power switch 30 is pressed and sends a power off signal to the virtual voltage converter 101 via a signal line Bus_{—}1. The virtual voltage converter 101 sends the power off signal to the virtual power sequence control module 201. The virtual power sequence control module 201 set the PS_ON pin to a high level to turn off the system voltage of 12V.

In another embodiment, a power off system command is inputted into the micro control unit 300, and the micro control unit 300 sends a shut down signal, such as a Bmc_Shutdown signal, to the virtual power sequence control module 201. The virtual power sequence control module 201 detects the Pch_S1p4 pin to be at a high level, then sends a power off signal to the virtual voltage converter 101 via the signal line S1. The virtual voltage converter 101 sends the power off signal to the virtual power sequence control module 201. The virtual power sequence control module 201 sets the PC_ON pin to be at a high level, to shut down the server.

The server analyzing system can also analyze signals during an abnormal status of the server in one embodiment, where, for example, the module power supply of 0.75V fails to be powered on, set by the abnormal setting module 10. The virtual voltage converter 101 receives an abnormal signal then sends an abnormal signal to the first debug display control module 105. The first debug display control module 105 selectively illuminates the plurality of light emitting diodes (LEDs) so that an end user may be warned that the power supply is not powered on normally. The register transfer level control module 102 controls the blink rate of each of the plurality of LEDs. The blink rate of each of the plurality of LEDs may be 4 HZ/S or 2 HZ/S. The virtual power sequence control module 201 sends a power abnormal signal to the virtual voltage converter 101 after waiting for a predetermined time and sends the power abnormal signal to the virtual voltage converter 101 via the signal line Bus_{—}1. The virtual voltage converter 101 powers off the modules. The decoding and data transmission module 203 sends the abnormal sequence signal to the micro control unit 300 via a signal line Bus_{—}3. The micro control unit 300 displays the abnormal sequence to the display module 400 and saves the abnormal sequence to the storage 95.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A server analyzing system, comprising:
a field programmable gate array;
a complex programmable logic device electrically connected to the field programmable gate array;
a micro control unit electrically connected to the field programmable gate array; and
a display module electrically connected to micro control unit;
wherein the complex programmable logic device and the micro control unit are capable of controlling the field programmable gate array to power on/off; the field programmable gate array is capable of saving time sequences when the field programmable gate array is powering on/off and outputting the time sequences on the display module, and the micro control unit is capable of receiving a command and sending the command to the field programmable gate array to execute from the display module.

2. The server analyzing system of claim 1, further comprises a decoding display module electrically connected to the field programmable gate array, wherein the field programmable gate array sends out decoding instructions to the decoding display module when the field programmable gate array is powering on/off.

3. The server analyzing system of claim 1, wherein the field programmable gate array comprises a virtual power sequence control module, the complex programmable logic device comprises a virtual voltage converter, the virtual power sequence control module is capable of sending a starting system power signal to the virtual voltage converter, the virtual voltage converter is capable of sending a starting system power feedback signal to the virtual power sequence control module, and the virtual power sequence control module starts the system power.

4. The server analyzing system of claim 3, wherein the virtual power sequence control module is capable of sending a starting module power signal to the virtual voltage converter, the virtual voltage converter receives the starting module power signal to start the module power and sends a module power started feedback signal to the virtual power sequence control module.

5. The server analyzing system of claim 3, further comprises a power button electrically connected to the field programmable gate array, wherein the virtual power sequence control module is capable of receiving a power starting pulsing signal when the power button is pressed.

6. The server analyzing system of claim 1, wherein the complex programmable logic device further comprises a system reset control module, the field programmable gate array further comprises a virtual reset sequence control module, the system reset control module is capable of sending a reset signal to the virtual reset sequence control module, and the virtual reset sequence control module is capable of resetting the system.

7. The server analyzing system of claim 6, further comprising a reset button electrically connected to the field programmable gate array, wherein the field programmable gate array further comprises a reset control module, the reset control module is capable of receiving a reset pulsing signal when the reset button is pressed and sending the reset signal to the system reset control module.

8. The server analyzing system of claim 7, further comprising an abnormal setting module, wherein the complex programmable logic device further comprises a first debug display control module, the virtual voltage converter is capable of receiving an abnormal signal via setting the abnormal setting module and stopping the module power to start, the virtual sequence control module is capable of sending a power abnormal signal to the first debug display control module after a predetermined time, and the first debug display control module starts a plurality of light emitting diodes when receives the power abnormal signal.

9. The server analyzing system of claim 1, further comprises a temperature controller electrically connected to the micro control unit and a temperature sensor connected to the temperature controller, wherein the complex programmable logic device further comprises a first temperature control module, the field programmable gate array further comprises a second temperature control module; the temperature sensor is capable of sensing a system temperature value, the temperature controller is capable of determining whether the system temperature value is greater than a predetermined temperature value, when the system temperature value is greater than the predetermined temperature, the temperature controller is capable of sending a temperature abnormal signal to the second temperature control module, and the second temperature control module is capable of sending the temperature abnormal signal to the first temperature control module and to shut down the system.

10. The server analyzing system of claim 9, further comprising a storage, wherein the storage is capable of saving the abnormal data.

11. A server analyzing system, comprising:
a field programmable gate array;
a complex programmable logic device electrically connected to the field programmable gate array;
a micro control unit electrically connected to the field programmable gate array;
a display module electrically connected to micro control unit; and
a logic port module electrically connected to the field programmable gate array, wherein the complex programmable logic device and the micro control unit are capable of controlling the field programmable gate array to power on/off; the field programmable gate array is capable of saving time sequences when the field programmable gate array is powering on/off and outputting the time sequences on the display module, the logic port module is capable of displaying the time sequences, and the micro control unit is capable of receiving a command and sending the command to the field programmable gate array to execute from the display module.

12. The server analyzing system of claim 11, further comprises a decoding display module electrically connected to the field programmable gate array, wherein the field programmable gate array outputs running codes to the decoding display module when field programmable gate array is powering on/off.

13. The server analyzing system of claim 11, wherein the field programmable gate array comprises a virtual power sequence control module, the complex programmable logic device comprises a virtual voltage converter, the virtual power sequence control module is capable of sending a starting system power signal to the virtual voltage converter, the virtual voltage converter is capable of sending a starting system power feedback signal to the virtual power sequence control module, and the virtual power sequence control module starts the system power.

14. The server analyzing system of claim 13, wherein the virtual power sequence control module is capable of sending a starting module power signal to the virtual voltage converter, the virtual voltage converter receives the module power signal to start the module power and send a module power started feedback signal to the virtual power sequence control module.

15. The server analyzing system of claim 13, further comprises a power button electrically connected to the field programmable gate array, wherein the virtual power sequence control module is capable of receiving a power starting pulsing signal when the power button is pressed.

16. The server analyzing system of claim 11, wherein the complex programmable logic device further comprises a system reset control module, the field programmable gate array further comprises a virtual reset sequence control module, the system reset control module is capable of sending a reset signal to the virtual reset sequence control module, and the virtual reset sequence control module is capable of executing the system reset.

17. The server analyzing system of claim 16, further comprising a reset button electrically connected to the field programmable gate array, wherein the field programmable gate array further comprises a reset control module, the reset control module is capable of receiving a reset pulsing signal when the reset button is pressed and sending the reset signal to the system reset control module.

18. The server analyzing system of claim 17, further comprising an abnormal setting module, wherein the complex programmable logic device further comprises a first debug display control module, the virtual voltage converter is capable of receiving an abnormal signal via setting the abnormal setting module and stopping the module power from starting, the virtual sequence control module is capable of sending a power abnormal signal to the first debug display control module after a predetermined time, and the first debug display control module selectively starts a plurality of light emitting diodes when receives the power abnormal signal.

19. The server analyzing system of claim 11, further comprises a temperature controller electrically connected to the micro control unit and a temperature sensor connected to the temperature controller, wherein the complex programmable logic device further comprises a first temperature control module, the field programmable gate array further comprises a second temperature control module; the temperature sensor is capable of sensing a system temperature value, the temperature controller is capable of determining whether the system temperature value is greater than a predetermined temperature value, when the system temperature value is greater than the predetermined temperature, the temperature controller is capable of sending a temperature abnormal signal to the second temperature control module, and the second temperature control module is capable of sending the temperature abnormal signal to the first temperature control module and to shut down the system.

20. The server analyzing system of claim 19, further comprising a storage, wherein the storage is capable of saving the abnormal data.
